(19) United States
(12) Patent Application Publication
(10) Pub. No.: US 2007/0140224 A1
(43) Pub. Date: Jun. 21, 2007

(54) Personal gateway and the method of processing the same

(76) Inventors: Chien-Chung Cheng, Hsinchu (TW); Kirubakaran Kalamegam, Hsinchu (TW); Kuen-Ruey Lu, Hsinchu (TW); Yi-Yuan Yang, Hsinchu (TW); Fuh-Jang Lin, Hsinchu (TW); Ming-Ling Lo, Hsinchu (TW)

Correspondence Address: THE MAXHAM FIRM, 9330 SCRANTON ROAD, SUITE 350, SAN DIEGO, CA, 92121, US

(21) Appl. No.: 11/315,400

(22) Filed: Dec. 21, 2005

(51) Int. Cl. H04L 12/66

(52) U.S. Cl. 370/352

(57) ABSTRACT

The present invention provides a personal gateway comprising a controller, a voice port chip for VOIP (voice over Internet Protocols) application coupled to said controller and a pair of connectors comprising a Foreign exchange Subscriber (or Foreign exchange Station; FXS) and a Foreign exchange Office (FXO). A status detector is coupled between said controller and said FXO and a relay is coupled between said voice port chip and said pair of connectors. The gateway further comprises an antenna and a wireless (RF) module coupled to said antenna to communicate with said controller for wireless LAN function.

### FIELD OF THE INVENTION

The present invention related to a gateway, more particularly, to a personal gateway and the method of processing the same.

### BACKGROUND OF THE INVENTION

Retrospect to technology history of 90's, the Internet growth seems to be the most important thing. The influence of the Internet on people's life is self-evident. Nowadays, because of the sharing feature of the Internet, people don't have to go to a physical place or meet someone personally for obtaining and exchanging information.

Originally, people on Internet interchange messages by means of a mail, a bbs (Bulletin Board System) or a website board. The demand of users accompanying with the Internet growth is a more instant and convenient method or device for communicating. Many instant message (IM) applications have been developed, which includes, but not limited to, ICQ™, MSN™, Jabber™. Soon after that, VOIP (voice over IP) technology, like Skype™, comes up. Since this technology has the potential to provide increased communication flexibility and much cheaper phone service, particularly internationally, VOIP technology owns the requisite quality of service for communications. However, some shortcomings exist in VOIP application. One such is that a VOIP user wanting to make a call should through a phone, gateway and a modem. Too much devices brings much inconvenience. Another is the usual VOIP device does not have a save knob for urgent incident. The other is that when a user makes a call through Internet, the user should convert to the PSTN mode and dial again by himself as the Internet is broken. The present invention addresses such problems to provide a novel method and system of a personal gateway.

### SUMMARY OF THE INVENTION

In accordance with a preferred embodiment of the present invention, there is provided a personal gateway preparing an accessible way for a VOIP user. The personal gateway includes a controller, voice port chip and status detector. The voice port chip is coupled to the controller. Programmable SPI interface and PCM interface supports up 64 channels connect to the voice chip for VOIP (voice over Internet) application. The status detector detects the ring, on/off hook for incoming calls, it may be used to detect whether the Internet is available or not. And the detect result will be sent to the controller. Afterward the controller will determine to switch a relay for connecting or not. Thus the status detector detects the valid incoming ring signal, the on/hook status of the user's phone, and the state of the Internet. Then the controller judges by the result via the status detector.

The personal gateway also contains a wireless (RF) module and antenna for wireless LAN function. Additionally, one Fast Ethernet connector coupled to the controller for connecting to WAN. Another Fast Ethernet connector through PHY 165 coupled to the controller for connecting to LAN.

Moreover, a GPS module is further included in the personal gateway. The GPS module could couple to an external server that is coupled to a client terminal. Through the GPS module, the client terminal will verify the position of the personal. Thus, the user may send out an emergency call via the personal gateway coupled a phone with an emergency key. If the user presses the emergency key, the location of the user will be defined by means of the GPS module.

Detailed description of the present invention will be expressed by the following description of a preferred embodiment taken together with the accompanying drawings and the appended calim.

### BRIEF DESCRIPTION OF THE DRAWINGS

FIG. 1 illustrates the functional diagram according to the present invention.

FIG. 2 is the flow chart of the method according to the present invention.

FIG. 3 is the flow chart of the method according to the present invention.

### DETAILED DESCRIPTION OF THE PREFERRED EMBODIMENTS

In the following description, numerous specific details are provided in order to give a thorough understanding of embodiments of the invention. One skilled in the relevant art will recognize, however, that the invention may be practiced without one or more of the specific details. In other instances, well known structures, materials, or operations are not shown or described in order to avoid obscuring aspects of the invention.

Referenced throughout the specification to “one embodiment” or “an embodiment” means that a particular feature, structure, or characteristic described in connection with the embodiment and included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

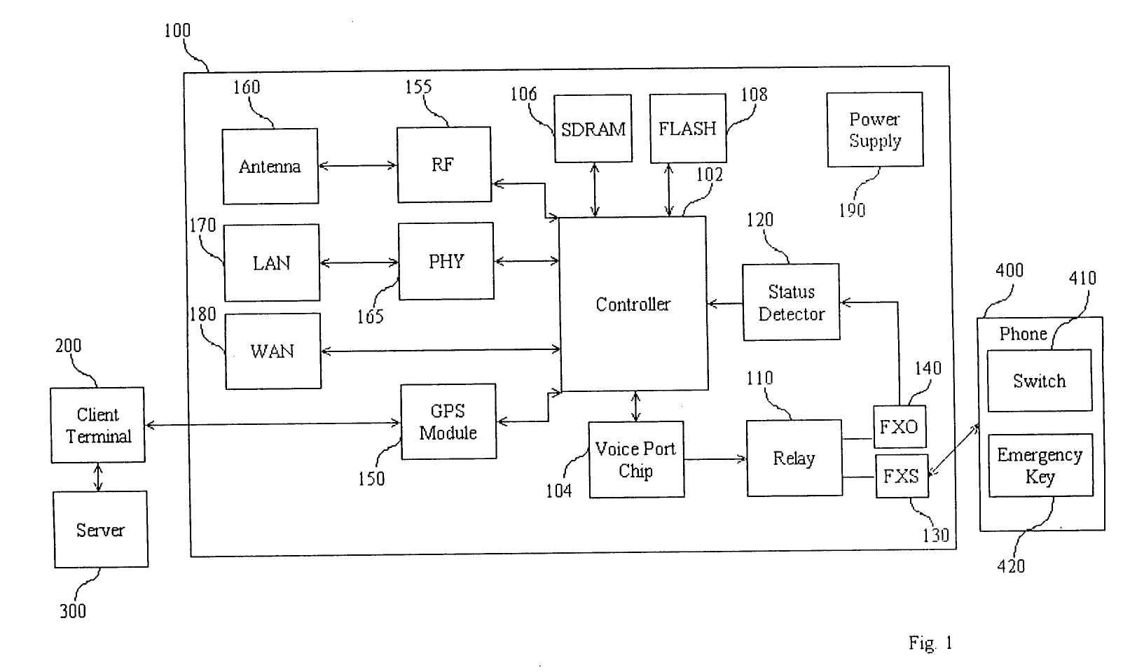

The present invention provides a complete all-in-one compact networking device for business travelers and home user. Please refer to FIG. 1, the personal gateway 100 according to the present invention includes a controller 102 to process the signal or instruction. The controller 102 has inbuilt IEEE 802.11 MAC and BBP (base band processor) for wireless communication. The controller could be, for instance, ADM8668 made by the Infineon Ltd,. A voice port chip 104 is coupled to the controller. Programmable SPI interface and PCM interface supports up 64 channels connect to the chip 104 for VOIP (voice over Internet) application. In one embodiment, the chip 104 could be the commercial product LE88111 made by the Legerity. The personal gateway 100 provides wireless 802.11a/b/g 3 modes, 2 10/100 Mbps auto-sensing Ethernet ports and 2 Ethernet connector (FXO and FXS) 130, 140 with RJ11 ports. A relay 110 is coupled between the voice port chip 104 and the FXO and FXS connectors 130, 140. The FXS refers to Foreign eXchange Subscriber (or Foreign eXchange Station) and FXO refer to a Foreign eXchange Office, as well known in the art. The relay 110 is incorporated to switch the signal between the FXO connector 130 and FXS connectors 140. A status detector 120 is coupled to the FXO connector 140 to detect whether the Internet is available or not. If the detect result is negative, the detecting signal will be sent to the controller 102. Subsequently, the controller 102 will switch the relay 110. The FXS connector 130 is coupled to an external device 400 having a switch 410 and emergency key 420. The switch 410 is provided to switch the relay 110 by manual. The FXS connector 130 can be connected to the traditional phone set 400 and used for VOIP communication. The emergency key 420 is used to send out an emergency call.

The FXO status detector 120 can detect the ring, on/off hook for incoming calls, it may optionally be used to detect the status of the Internet status for detecting whether the Internet is available or not. Thus, the FXO status detector 120 may includes ring detector, On/Off hook detect, and Internet capability detector. For out going calls, the personal gateway sets the VOIP as default. Each time when the phone is on hook, it sets back to VOIP as default. The user needs to push the switch 410 on the phone 400 each time to make PSTN calls.

The ring detect is used to detect the incoming ring signal. The ring detector has an optical isolator used to perform the function. The purpose of the optical isolation is to isolate the gateway from PSTN line which gives up to 3750 Vrms isolation, and convert the incoming ring signal into pulse signal. The output of the ring detector is connected the CPU (controller 102) to make sure the valid incoming ring signal. The on/off hook detector is used to detect the on/hook status of the user's phone. The on/hook status is detected by loop detection method. A resistor is connected in serious with the TIP line. The on/off hook status is detected by loop method.

A wireless (RF) module 155 communicates with RF interface of the controller 102 to implement 802.11a/b/g wireless LAN function. An antenna 160 is coupled to the wireless module 155. The wireless module 155 can operate in either wireless client or access point mode. The personal gateway also includes plurality of auto-sensing Fast Ethernet connectors 170, 180 for Ethernet connection. One is WAN connector 180 coupled to the controller 102. Another LAN connector 170 through PHY (Port Physical Layer) 165 connected to the controller 102. Preferably, the present invention may provide two Ethernet ports (one with IEEE 802.3 Fast Ethernet MAC and PHY, the other with IEEE 802.3 Fast Ethernet MAC and reversed MII interface).

An optional GPS module 150 is coupled to the controller 102, wherein the GPS module 150 could couple to a client terminal 200 that is coupled to a server 300. Thus, the user may define the position of the personal gateway through the GPS module 150.

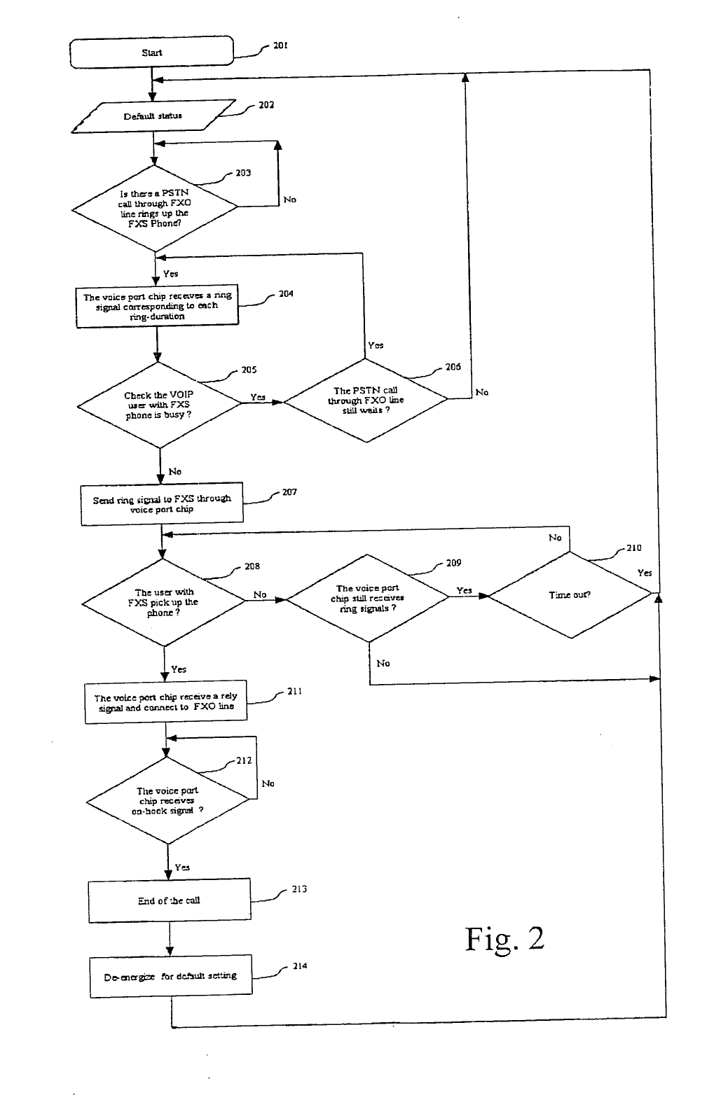

FIG. 2 shows a flow chart expresses how the personal gateway operation, when a PSTN call or Internet call through the FXO line rings up the FXS phone. Initially, step 201 represents that the personal gateway 100 prepares to operate and step 202 represents that the default status of the circuit within the personal gateway. The status detector 120 within the personal gateway 100 will verify whether a PSTN call through the FXO line rings up the FXS phone in step 203. Provided that a PSTN call exactly rings up, the voice port chip 104 stated above will receive a ring pulse signal corresponding to each ring duration in step 204. For example, the voice port chip 104 may be but not limit to the commercial product Le88111 produced by Legerity, Inc. of USA. The GPIO 1 port on Le88111 programmed to receive a ring signal corresponding to each ring-duration via the detector. And the GPIO 2 port of the Le88111 programmed to get a signal represents a line is busy or not via the status detector 120. Thus the controller 102 of the personal gateway 100 will check whether the FXS phone is busy or not via the port of the voice port chip in step 205. If the FXS phone is busy, the ring signal will stop unless the PSTN call does not wait for the FXS phone in step 206.

Assuming that the FXS phone is not busy, the controller 102 will accept to send a ring signal through the voice port chip 104 to the FXS phone for indicating the user with FXS having a call in step 207. Then the controller 102 verifies whether the user with FXS pick up the phone to connect the caller through the FXO line in step 208. Supposing the user with FXS does not pick up the phone, the controller 102 will distinguish whether the voice port chip 104 still receives a ring signal via the status detector 120 in step 209. Hypothesize that the voice port chip 104 does not receive a ring signal, the circuit within the personal gateway personal gateway 10 will back to the default status. Contrariwise, assuming that the voice port chip 104 still receives a ring signal, the FXO phone will continue getting ring signals until time out in step 210.

Supposing that the user with FXS picks up the phone, the controller 102 will energize a relay signal to the voice port chip 104 for connecting the caller through the FXO line in step 211. After the interconnection of the user with FXS phone and the caller through FXO line, the controller will distinguish whether the calling finished by means of the status detector 120 and the voice port chip 104 in step 212. That is, when the user or the caller on-hook the phone, the voice port chip 104 will receive a signal indicating on-hook via the status detector 120 and the call is finished in step 213. Finally, the controller 102 will de-energize the relay signal for default setting in step 214.

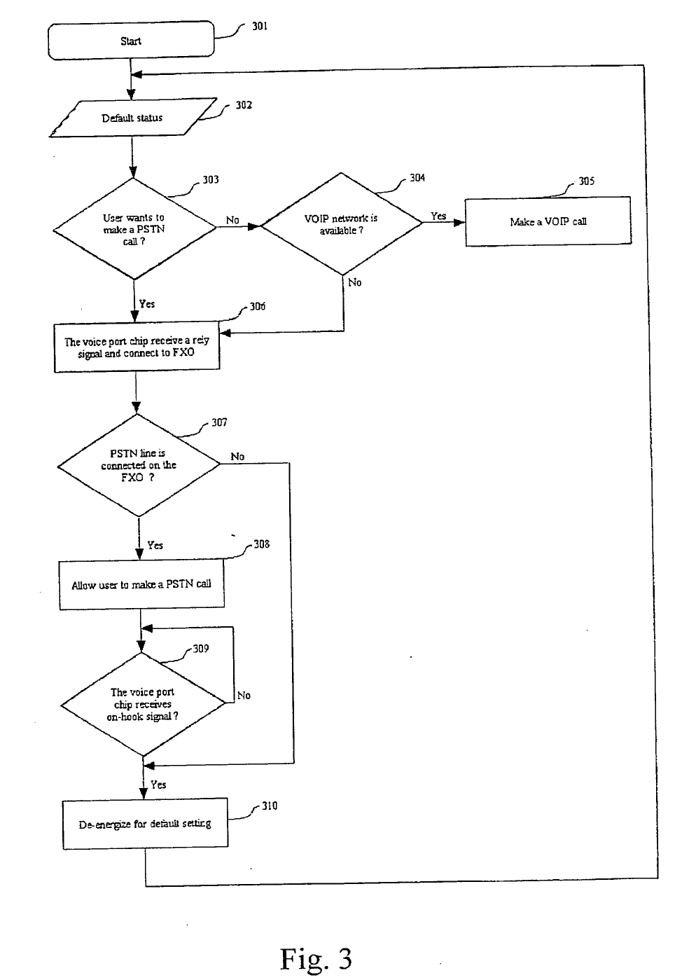

FIG. 3 shows a flow chart expresses that when a user with the FXS phone makes a PSTN call through the FXO line, the personal gateway how to proceed.

Initially, step 301 represents that the personal gateway 100 prepares to be operated and step 302 represents that the default status of the circuit within the personal gateway. Because the default status of the present personal gateway 100 is that the user would make the call through VOIP technology, the user wanting to make a PSTN call could enter the switch key as the above-expressed switch 410 for converting to the PSTN mode. The switch 410 may be but not limited to a knob on the user phone. The controller 102 notices that the user presses the switch 410 or not in step 303. Assuming that the user wants to convert to PSTN mode, the controller 102 will energize a relay signal to the voice port chip as above-mentioned 104 for connecting the FXO in step 306.

On the contrary, if the user does not want to convert to PSTN mode, the controller will detect the status of the Internet in step 304. When the Internet is not overloading or broken, the controller 102 will allow the user to make a VOIP call in step 305. Otherwise, the controller 102 will connect to the PSTN automatically as the Internet is not available, consequentially, the controller will energize a relay signal to the voice port chip for connecting the relay 110 to switch to the FXO in step 306.

Then, the controller will check the PSTN line is connected on FXO in step 307. Hypothesize that the PSTN line is connected on FXO, the controller 102 will allow the user to make a PSTN call in step 308. Otherwise, the personal gateway will back to the default status in step 310 when the PSTN line is not connected on FXO. During the user making a call, the controller will distinguish whether the calling finished by means of the status detector 120 and the voice port chip 104 in step 309. That is, when the user or the caller on-hook the phone, the voice port chip 104 will receive a signal indicating on-hook via the status detector 120. Finally, the controller 102 will de-energize the relay signal for default setting in step 310.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A personal gateway comprising:
a controller;
a voice port chip for VOIP (voice over Internet Protocols) application coupled to said controller;
a pair of connectors comprising a Foreign exchange Subscriber (or
Foreign exchange Station; FXS) and a Foreign exchange Office (FXO);
a status detector coupled between said controller and said FXO; and
a relay coupled between said voice port chip and said pair of connectors.

2. The personal gateway as set forth in claim 1, further comprising:
an antenna; and
a wireless(RF) module coupled to said antenna to communicate with said controller for wireless LAN function.

3. The personal gateway as set forth in claim 1, further comprising:
a Port Physical Layer(PHY) coupled to said controller; and
a Fast Ethernet LAN connector through said PHY connected to said controller for Ethernet connection.

4. The personal gateway as set forth in claim 1, further comprising: a Fast Ethernet WAN connector coupled to said controller for Ethernet connection.

5. The personal gateway as set forth in claim 1, wherein said status detector is employed to detect the ring and on/off hook of said FXO and FXS connectors and is responsive to a detecting result to sent said detecting result to said controller.

6. The personal gateway as set forth in claim 1, wherein said status detector further detects Internet capability and is responsive to a detecting result to sent said detecting result to said controller.

7. The personal gateway as set forth in claim 1, wherein said controller is employed to switch said rely for establishing connection between said FXO connector and said FXS connector via a detecting result of said status detector.

8. The personal gateway as set forth in claim 1, wherein said controller is employed to determine whether or not to connect to an Internet via a detecting result of said status detector.

9. The personal gateway as set forth in claim 1, further comprising a Global Positioning System(GPS) module coupled to said controller for defining the position of said personal gateway.

10. The personal gateway as set forth in claim 1, wherein an external device having an emergency key is coupled to said personal gateway, and said emergency key sending out an emergency message.

11. A method for operating incoming calls of a personal gateway comprising:
verifying whether or not a PSTN call through a FXO line rings up said FXS phone by a status detector;
if positive, said status detector checking whether or not said FXS phone is free;
if positive, then sending a signal through a voice port chip for indicating said FXS phone having a call;
verifying whether said FXS phone is picked up or not;
when said FXS phone is picked up, switching a relay by a controller to connect said FXO line;
when said FXS phone connects to said FXO line, said controller checking whether the calling is end or not via said status detector; and
wherein said calling is end, said controller setting a default setting.

12. The method as set forth in claim 11, further comprising a step of receiving a pulse signal corresponding to each ring duration before said step of checking whether said FXS phone is free.

12. The method as set forth in claim 11, further comprising a step of determining whether said PSTN call through FXO line still waits if said FXS phone is not free.

13. The method as set forth in claim 11, further comprising a step of determining whether a VOIP chip still receives a ring signals when said FXS phone is not picked up.

14. The method as set forth in claim 11, further comprising a step of determining whether receives a on-hook signals before ending said call.

15. A method for making calls of a personal gateway comprising:
verifying whether a call is made through a VOIP network;
if positive, determining by a status detector whether a network is available or not;
if said network capability is available enough for VOIP, then making a VOIP call by a controller.

16. The method as set forth in claim 15, further comprising a step of receiving a relay signal by a voice port chip and connecting to FXO line if said variation of said call is not made through a VOIP network.

16. The method as set forth in claim 15, further comprising a step of, if said network capability is not available enough for VOIP, making a PSTN call.

17. The method as set forth in claim 16, further comprising a step of determining whether a voice port chip receives an on-hook signal or not after making said PSTN call.

18. The method as set forth in claim 16, further comprising a step of, if said controller tries to make a PSTN call, verifying whether said FXO line is coupled to a PSTN line or not.

19. The method as set forth in claim 18, further comprising a step of, if said FXO line is coupled to said PSTN line, said voice port chip receiving a relay signal to switch a relay for connecting said FXO line.

20. The method as set forth in claim 15, further comprising a step of setting a default setting when the calling is end.
